(19) United States
(12) Patent Application Publication
(10) Pub. No.: US 2023/0043919 A1
(43) Pub. Date: Feb. 9, 2023

(54) PRINTING APPARATUS, PRINTING METHOD, AND CAN BODY

(71) Applicant: Toyo Seikan Co., Ltd., Tokyo (JP)

(72) Inventors: Kenichiro YAMAMOTO, Tokyo (JP); Hisaaki MORIKAWA, Tokyo (JP); Kouji YAMADA, Kanagawa (JP)

(21) Appl. No.: 17/949,596

(22) Filed: Sep. 21, 2022

Related U.S. Application Data
(63) Continuation of application No. PCT/JP2021/004155, filed on Feb. 4, 2021.

(30) Foreign Application Priority Data
Apr. 1, 2020 (JP) 2020-065994

(51) Int. Cl. B41F 16/00; B41M 1/14; B41M 1/40

(52) U.S. Cl. CPC B41F 16/0086; B41F 16/0033; B41M 1/14; B41M 1/40

(57) ABSTRACT

A printing apparatus configured to print a can body includes: a plurality of printing plates; a blanket; a blanket transfer device configured to transfer inks on the plurality of printing plates to the blanket; and a can body transfer device configured to transfer the inks transferred to the blanket to the can body. The blanket transfer device transfers the inks such that at least part of an ink transferred from one printing plate is superimposed onto at least part of inks in other colors transferred from other printing plates.

### CROSS-REFERENCE TO RELATED APPLICATIONS

The present application is a continuation application of PCT international application No. PCT/JP2021/004155 filed on Feb. 4, 2021 which claims priority from Japanese Pat. Application No. 2020-065994 filed on Apr. 1, 2020, and the entire contents of which are hereby incorporated by reference.

### BACKGROUND

### 1. Technical Field

The present invention relates to a printing apparatus, a printing method, and a can body.

### 2. Related Art

Images with various designs are printed on the outer circumferential surfaces of can bodies used for beverage cans. In many cases, these can bodies are offset printed in order to achieve high-speed production.

For example, Japanese Pat. Application Laid-Open No. H02-262657 describes a printing technique to perform printing by using printing plates having convex portions for respective colors which do not overlap each other. Each of the inks on the convex portions of the printing plates is transferred to one blanket, and all the colors of the transferred inks are transferred to a can body supported by a rotor at the same time. The entire contents of which are hereby incorporated by reference.

### SUMMARY

According to the invention, a printing apparatus configured to print a can body includes: a plurality of printing plates; a blanket; a blanket transfer device configured to transfer inks on the plurality of printing plates to the blanket; and a can body transfer device configured to transfer the inks transferred to the blanket to the can body. The blanket transfer device transfers the inks such that at least part of an ink transferred from one printing plate is superimposed onto at least part of inks in other colors transferred from other printing plates.

### BRIEF DESCRIPTION OF THE DRAWINGS

FIG. 1 schematically illustrates the basic configuration of a printing apparatus according to an embodiment;

FIG. 2 is an enlarged view illustrating the vicinity of a region in which a printing plate and a blanket illustrated in FIG. 1 contact one another;

FIG. 3 is a partial cross sectional view illustrating a printing plate which is a waterless planographic plate;

FIG. 4 is a flowchart illustrating the printing operation of the printing apparatus to print a can body;

FIG. 5 is a block diagram illustrating functions of a plate-making system configured to manufacture printing plates attached to the printing apparatus;

FIGS. 6A-6B illustrate a first example of setting a condition for under color removal processing;

FIGS. 7A-7B illustrate a second example of setting a condition for the under color removal processing;

FIGS. 8A-8C illustrate a third example of setting a condition for the under color removal processing; and

FIG. 9 is a flowchart illustrating plate-making operation to manufacture printing plates by using the plate-making system.

### DETAILED DESCRIPTION

With the printing technique using the printing plates as described in Japanese Pat. Application Laid-Open No. H02-262657, designs with solid painting or designs and characters by solid painting can be printed on a can body, but there is a problem that it is difficult to realistically print precise designs, for example, as photography on the can body.

The present invention has been achieved considering the above-described circumstances to address the above-described problems. It is therefore an aspect of the object of the invention to provide a printing apparatus and a printing method capable of realistically printing precise designs on a can body, and the can body thereby.

Hereinafter, an embodiment of the invention (present embodiment) will be described with reference to the drawings.

### Basic Configuration of Printing Apparatus

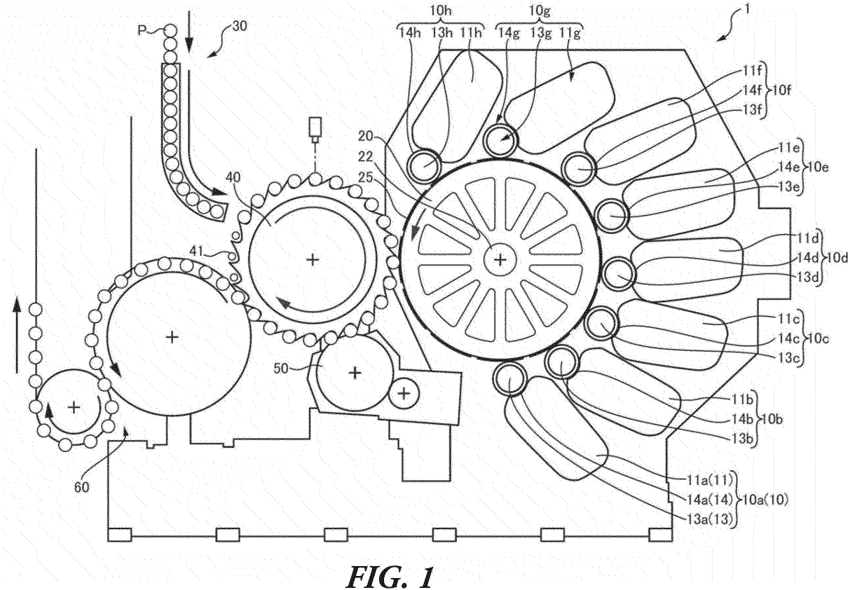

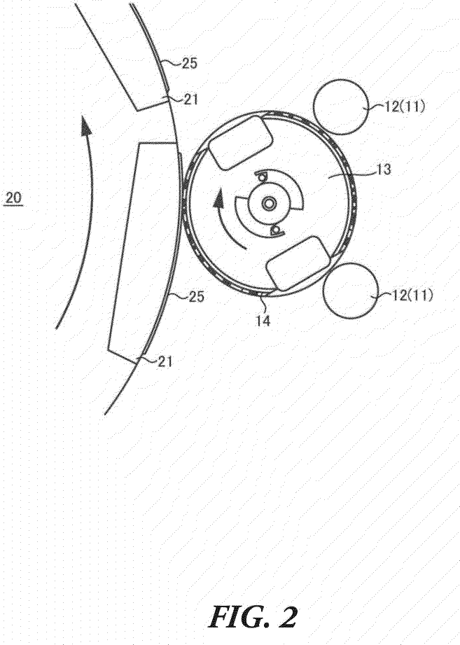

FIG. 1 schematically illustrates the basic configuration of a printing apparatus according to the present embodiment. FIG. 2 is an enlarged view illustrating the vicinity of a region in which a printing plate and a blanket illustrated in FIG. 1 contact one another.

A printing apparatus 1 illustrated in FIG. 1 is a printing apparatus for offset printing configured to print a can body (printed material) P such as a two-piece can having an approximately cylindrical shape, by transferring ink to the outer circumferential surface (outer surface) of the can body P.

As illustrated in FIG. 1, the printing apparatus 1 includes inking units 10, a blanket wheel 20, a conveyance unit 30, a mandrel wheel 40, a varnish applicator 50, and a transport unit 60.

The inking units 10 are devices configured to supply ink to printing plates 14. The inking unit 10 may be referred to as inker units. The inking units 10 are constituted by a plurality of inking units for inks in respectively different colors, that is, constituted by a first inking unit 10a to an eighth inking unit 10h. These inking units 10 are arranged along the outer circumferential surface of the blanket wheel 20. Each of the inking units 10 includes an ink supply part 11 configured to store a predetermined ink, and a plate cylinder 13 to which the printing plate 14 corresponding to the ink in the ink supply part 11 is mounted.

The plurality of ink supply parts 11 are constituted by a first ink supply part 11a to an eighth ink supply part 11h. The plurality of printing plates 14 are constituted by a first printing plate 14a to an eighth printing prate 14h to which the inks are supplied from the first ink supply part 11a to the eighth ink supply part 11h, respectively. The plate cylinders 13 are constituted by a first plate cylinder 13a to an eighth plate cylinder 13h to which the first printing plate 14a to the eighth printing plate 14h are mounted, respectively.

With the example of the printing apparatus 1 illustrated in FIG. 1, the first ink supply part 11a stores the ink in yellow (Y), the second ink supply part 11b stores the ink in magenta (M), and the third ink supply part 11c stores the ink in cyan (C).

On the other hand, the fourth ink supply part 11d to the eighth ink supply part 11h do not store ink. Therefore, the fourth printing plate 14d to the eighth printing plate 14h respectively corresponding to the fourth ink supply part 11d to the eighth ink supply part 11h are not supplied with ink.

As illustrated in FIG. 2, the ink supply part 11 includes an ink roller group 12 constituted by a fountain roller, a foam roller and so forth. The ink supply part 11 supplies the ink stored in an ink repository (not illustrated) to the printing plate 14 mounted to the plate cylinder 13, by rotating the rollers of the ink roller group 12. Temperature-controlled water is circulated in part of the rollers of the ink roller group 12 to appropriately keep the temperature of the ink.

The plate cylinder 13 has an approximately cylindrical shape and can rotate around a spindle, and the printing plate 14 is detachably mounted to the outer circumferential surface of the plate cylinder 13. The plate cylinder 13 is provided such that the distance from the blanket wheel 20 can be changed. The plate cylinder 13 may be referred to as a printing cylinder.

To represent colors other than the colors extracted by the color separation, the plurality of printing plates 14 (first printing plate 14a to eighth printing plate 14h) are manufactured to overprint the colors extracted by the color separation by the overprint method. As described later, a plate-making system 100 applies halftone dot forming processing to plate separation image data for each of the colors which is obtained by separating the colors of original image data, and the plurality of printing plates 14 are manufactured, based on the image data for plate-making (plate making image data) which represents halftone dots in each of the colors. Therefore, the plurality of printing plates 14 for the overprinting by the overprint method are manufactured depending on the plate-making image data representing halftone dots in each of colors. That is, the plate-making image data of a halftone dot image has a superimposed portion (an overlap portion) in which the image data representing the halftone dots in each of the colors is superimposed onto each other such that at least part of the halftone dots in one color is superimposed onto at least part of the halftone dots in the other colors (to form an overlapping part).

This printing apparatus 1 can reproduce various colors by the overlap of a plurality of colors, and therefore can realistically print precise designs, for example, as photography, on a can body.

In the printing apparatus 1, the ink in yellow (Y) is supplied from the first ink supply part 11a to the first printing plate 14a; the ink in magenta (M) is supplied from the second ink supply part 11b to the second printing plate 14b; and the ink in cyan (C) is supplied from the third ink supply part 11c to the third printing plate 14c. In this way, the ink in yellow (Y), the ink in magenta (M), and the ink in cyan (C) are put on the first printing plate 14a, the second printing plate 14B, and the third printing plate 14c, respectively, and the colors of the inks put on the printing plates are gradually changed from the color with high lightness (light color: yellow (Y)) on the first printing plate 14a to the color with low lightness (dark color: cyan (C)) on the third printing plate 14c.

The printing apparatus 1 transfers the inks to the blankets 25 by a so-called wet-on-wet method in which a process to dry the inks is not performed until all the inks have been transferred (laminated) onto the same (one) blanket 25. With this wet-on-wet method, the printing apparatus 1 does not perform the dry process, but transfers (laminates) the inks in the colors onto the same blanket 25 sequentially from the corresponding first printing plate 14a, second printing plate 14b and third printing plate 14c, respectively in this order. In this case, the inks in different colors are transferred onto the same blanket 25 such that the colors are gradually changed from the color with high lightness (light color: yellow (Y)) on the first printing plate 14a to the color with low lightness (dark color: cyan (C)) on the third printing plate 14c. By this means, at least part of the halftone dots in the dark color with low lightness is superimposed onto at least part of the halftone dots in the light color with high lightness in the same blanket 25.

After all the inks are transferred (laminated) onto the same blanket 25, the inks in all the colors on this blanket 25 are transferred onto the outer circumferential surface (outer surface) of the can body P at the same time. By this means, a halftone dot image in which at least part of the halftone dots in one color is superimposed onto at least part of the halftone dots in the other colors is printed on the outer circumferential surface of the can body P. To be more specific, the halftone dot image in which at least part of the halftone dots in the light color with high lightness is superimposed onto at least part of the halftone dots in the dark colors with low lightness is printed on the outer circumferential surface of the can body P. After that, the can body P is moved from the mandrel 41 to a dryer such as an oven (not illustrated). The printing apparatus 1 adopts the wet-on-wet method, and therefore can print a lot of cans at high speed.

However, when the wet-on-wet method is adopted for the overprinting by the overprint method as described, the inks may be mixed and murky in the superimposed portion in which the inks in different colors are superimposed onto each other. Therefore, the printing apparatus 1 employs waterless planographic plates as the printing plates 14 (first printing plate 14a to eighth printing plate 14h). The waterless planographic plate has image areas on which ink is put, and non-image areas on which ink is not put without water. This printing plate 14 which is a waterless planographic plate will be described in detail later.

For example, an outlet configured to blow out cold air may be provided in the vicinity of the plate cylinder 13, so that the temperatures of the plate cylinder 13 and the printing plate 14 are appropriately kept.

The blanket wheel 20 is a device to rotate the blankets 25 configured to rotate to contact the printing plates 14 and the can bodies P to transfer the inks supplied to the printing plates 14 onto the can bodies P. As illustrated in FIG. 1, the blanket wheel 20 has an approximately cylindrical shape and can rotate around a spindle 22. As illustrated in FIG. 2, a plurality of segments 21 are provided on the outer circumferential surface of the blanket wheel 20 and arranged at predetermined intervals along the circumferential direction of the blanket wheel 20. The blankets 25 are mounted to the outer surfaces of the plurality of segments 21, respectively. In the printing apparatus 1 illustrated in FIG. 1, twelve blankets 25 are mounted to the segments 21.

Each of the blankets 25 is an intermediate transfer member configured to mediate the transfer of the ink from the printing plate 14 to the can body P. The blanket 25 includes a base material layer made of fabric cloth and foam, and a rubber layer made of acrylonitrile butadiene rubber. The base material layer is detachably mounted to the outer surface of the segment 21 via an adhesive material. The ink on the printing plate 14 is transferred onto the rubber layer. The rubber layer is disposed on the outer surface of the base material layer and constitutes the outer surface of the blanket 25.

In the printing apparatus 1, the blanket wheel 20 rotates in the direction of an arrow illustrated in FIG. 1 (counterclockwise), and therefore the ink in yellow (Y) on the first printing plate 14a, the ink in magenta (M) on the second printing plate 14b, and the ink in cyan (C) on the third printing plate 14c are transferred, in this order, onto the same (one) blanket 25.

The conveyance unit 30 is configured to convey unprinted can bodies P to the mandrel wheel 40. As illustrated in FIG. 1, the conveyance unit 30 is provided above the mandrel wheel 40. The conveyance unit 30 is provided upstream of the rotating direction of the mandrel wheel 40 from the region in which the can body P held by the mandrel 41 contacts the blanket 25. The conveyance unit 30 conveys the can bodies P one by one from above the mandrel wheel 40 to the upper part of the mandrel wheel 40 by the gravity of the can body P.

The mandrel wheel 40 is a device configured to rotate the mandrels 41 holding the can bodies P. The mandrel wheel 40 is provided next to the blanket wheel 20 in the radial direction of the blanket wheel 20. The mandrel wheel 40 has an approximately disc shape and can rotate around the spindle. A plurality of mandrels 41 are provided on the outer circumference of the mandrel wheel 40 and arranged at predetermined intervals along the circumferential direction of the mandrel wheel 40.

Each of the mandrels 41 has an approximately cylindrical shape and can be inserted into the can body P. The plurality of mandrels 41 are arranged to protrude in the direction intersecting the mandrel wheel 40, and cantilevered by the outer circumference of the mandrel wheel 40. It is preferred that the number of the mandrels 41 is an integral multiple of the number of the blankets 25. In the printing apparatus 1 illustrated in FIG. 1, twenty-four mandrels 41 are provided on the mandrel wheel 40.

The front end of the mandrel 41 absorbs the inner surface of the bottom of the can body P by air suction, and therefore the can body P is held by the mandrel 41. The posture of the mandrel 41 can be changed, and the position of the mandrel 41 also can be changed in the radial direction of the mandrel wheel 40. The mandrel 41 is provided to be able to rotate around the central axis of the mandrel 41 while holding the can body P.

The varnish applicator 50 is a device configured to overcoat the can body P to which the ink has been transferred, with finishing varnish. The varnish applicator 50 is provided next to the mandrel wheel 40 in the radial direction of the mandrel wheel 40. The varnish applicator 50 is provided downstream of the rotating direction of the mandrel wheel 40 from the contact region where the can body P held by the mandrel 41 contacts the blanket 25.

The transport unit 60 is a device configured to transport the can body P having passed through the varnish applicator 50 from the mandrel 41 to a dryer such as an oven to fix the ink and the overcoat to the can body P. The transport unit 60 is provided next to the mandrel wheel 40 in the radial direction of the mandrel wheel 40. The transport unit 60 is provided downstream of the rotating direction of the mandrel wheel 40 from the contact region where the can body P held by the mandrel 41 contacts the varnish applicator 50.

### Waterless Planographic Plate

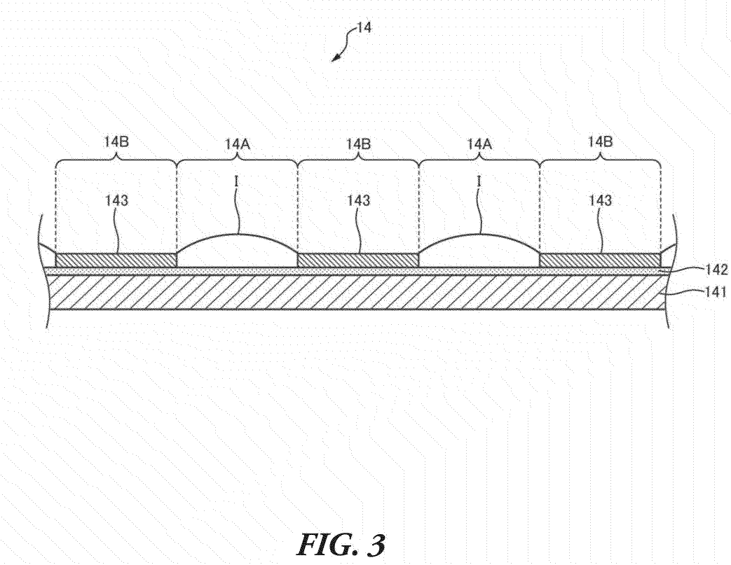

FIG. 3 is a partial cross sectional view illustrating the printing plate 14 which is a waterless planographic plate. As illustrated in FIG. 3, the printing plate 14 which is a waterless planographic plate includes a base plate 141, a laser heat-sensitive layer 142 and an ink repellent layer 143 which are laminated in this order.

Image areas 14A on which ink is put are formed by removing the ink repellent layer 143 to expose the laser heat-sensitive layer 142. Meanwhile, non-image areas 14B on which ink is not put are portions on which the ink repellent layer 143 is left. The ink repellent layer 143 forming the non-image areas 14B is made of resin such as silicone resin (silicone rubber). By this means, the non-image areas 14B repel ink, so that the ink is not put on the non-image areas 14B.

### Base Plate

As the base plate 141, well-known metal plate and film may be used as long as it is a plate material whose dimension is stable. The plate material whose dimension is stable is not limited, but any conventional base plates having been used for printing plates may be used. Examples of the plate material may include paper, paper on which plastic (polyethylene, polypropylene, and polystyrene) is laminated, steel, aluminum (including aluminum alloy), a plate made of metal such as zinc and copper, a film made of plastic such as cellulose acetate, polyethylene terephthalate, polyethylene, polyester, polyamide, polyimide, polystyrene, polypropylene, polycarbonate, and polyvinyl acetal, and paper or a plastic film on which metal is laminated or deposited.

### Laser Heat-Sensitive Layer

As the laser heat-sensitive layer 142, a laser heat-sensitive layer conventionally applied to a waterless planographic plate may be used. The laser heat-sensitive layer 142 may include a composition containing, for example, at least (a)a photothermal conversion material, (b)a metal chelate compound, (c) an active hydrogen-containing compound, and (d) binder resin.

When the laser heat-sensitive layer 142 includes this composition, it is preferred that a cross-link structure is previously formed by the metal chelate compound (b) and the active hydrogen-containing compound (c) before laser irradiation. By this means, the adhesion between the heat-sensitive layer and the silicone rubber of the laser-irradiated part deteriorates, and the silicone rubber of the laser-irradiated part is removed by subsequent processing, so that it is possible to obtain a waterless planographic plate.

### Photothermal Conversion Material (A)

The photothermal conversion material (a) is not limited as long as it absorbs the laser beam. The laser beam may have a wavelength in any of the ultraviolet region, the visible region, and the infrared region. The photothermal conversion material having an absorption region corresponding to the wavelength of the laser beam used may be appropriately selected and used. In particular, carbon black may be preferably used.

In addition, dye which absorbs ultra-violet rays or near infrared rays may be used as the photothermal conversion material. The dye having a maximum absorption wavelength of 700 to 900 nm may be preferably used.

The content of the photothermal conversion material is preferably from 0.1 to 40 % by weight, and more preferably from 0.5 to 25 % by weight based on the total composition of the heat-sensitive layer.

### Metal Chelate Compound (B)

Examples of the metal chelate compound (b) may include metal diketonate, metal alkoxide, alkyl metal, metal carboxylate salts, a metal oxide chelate compound, a metal complex, and a heterometal chelate compound.

Examples of the metal chelate compound particularly preferred may include aluminum, iron (III), titanium acetylacetonate (pentanedionate), ethyl acetoacetonate (hexanedionate), propyl acetoacetonate (heptanedionate), tetramethyl heptanedionate, and benzoyl acetonates. They may be used alone or in combination of two or more.

The content of the metal chelate compounds in the laser heat-sensitive layer 142 is preferably from 5 to 300 % by weight, more preferably from 10 to 150 % by weight, based on 100 % by weight of the active hydrogen group-containing compound (c).

### Active Hydrogen Group-Containing Compound (C)

Examples of the active hydrogen group-containing compound (c) may include a hydroxyl group-containing compound, an amino group-containing compound, a carboxyl group-containing compound, and a thiol group-containing compound, and, in particular, the hydroxyl group-containing compound is preferably used.

Examples of the hydroxyl group-containing compound may include a phenolic hydroxyl group-containing compound, an alcoholic hydroxyl group-containing compound, epoxy acrylate, epoxy methacrylate, polyvinyl butyral resin, and a polymer having a hydroxyl group introduced by a well-known method.

The content of the active hydrogen group-containing compounds (c) is preferably from 5 to 80 % by weight, more preferably from 20 to 60 % by weight based on the total composition of the laser heat-sensitive layer 142.

### Binder Resin (D)

The binder resin (d) is not limited as long as it can be dissolved in organic solvent and has a film forming property. Examples of the binder resin (binder polymers) which can be dissolved in organic solvent, and has a film forming property, and further has a function to maintain the morphology may include vinyl polymers, unvulcanized rubber, polyoxides (polyethers), polyesters, polyurethanes, and polyamides. They may be used alone or in combination of two or more.

The content of the binder polymers is preferably from 5 to 70 % by weight, more preferably from 10 to 50 % by weight, based on the total composition of the laser heat-sensitive layer 142.

### Other Than (A) To (D) (Others)

A leveling agent, a surface active agent, a dispersing agent, a plasticizer, a coupling agent and so forth may be optionally added to the laser heat-sensitive layer 142 as needed. In particular, in order to improve the adhesion to the base plate 141 (or primer layer) or the ink repellent layer 143, it is preferred that various coupling agents such as a silane coupling agent, and an unsaturated group-containing compound are added. The thickness of the laser heat-sensitive layer 142 is not limited.

### Ink Repellent Layer

It is preferred that the ink repellent layer 143 is made of, for example, silicone resin (silicone rubber). Examples of this silicone rubber may include silicone rubber conventionally used for the waterless planographic plate, and, for example, condensation reaction-type silicon rubber or addition reaction-type silicone rubber is applicable.

### Addition Reaction-Type Silicone Rubber

When the ink repellent layer 143 is made of addition reaction-type silicone rubber, the ink repellent layer 143 is formed by applying a silicone rubber composition containing at least a vinyl group-containing organopolysiloxane, a SiH group-containing compound (addition reaction-type cross-linking agent), a reaction inhibitor and a curing catalyst, and drying it as needed.

The vinyl group-containing organopolysiloxane has a structure represented by the following general formula (A), and has a vinyl group at the end of its main chain or in the main chain. In particular, the vinyl group-containing organopolysiloxane having a vinyl group at the end of its main chain is preferably used.

—(SiR¹R²—O—)ₙ— (A)

In the formula (A), n denotes an integer of 2 or more, and R¹ and R² may be the same or different, and each of them denotes a saturated or unsaturated hydrocarbon group having a carbon number of 1 to 50. The hydrocarbon group may be linear, branched or cyclic, and may contain an aromatic ring. In the formula (A), it is preferred that 50 % or more of the entire R¹ and R² are methyl groups in view of ink repellency of the printing plate. In addition, it is preferred that the weight average molecular weight of the vinyl group-containing organopolysiloxane is from 10,000 to 600,000.

Examples of the SiH group-containing compound may include an organohydrogen polysiloxane and an organic polymer having a diorganohydrogen silyl group, and in particular, an organohydrogen polysiloxane is preferably used.

It is preferred that the content of the SiH group-containing compounds is from 0.5 to 20 % by weight, in particular, from 1 to 15 % by weight in the silicone rubber composition.

Examples of the reaction inhibitor may include a nitrogen-containing compound, a phosphorus-based compound, an unsaturated alcohol, and in particular, an acetylene group-containing alcohol is preferably used. It is preferred that the content of the reaction inhibitor is from 0.01 to 20 % by weight, in particular, from 0.1 to 15 % by weight in the silicone rubber composition.

The curing catalyst may be selected from conventionally well-known catalysts, and preferably, may be a platinum-based compound. To be more specific, examples of the curing catalyst may include platinum (simple substance), platinum chloride, chloroplatinic acid, olefin-coordinated platinum, an alcohol-modified complex of platinum, and a methyl vinyl polysiloxane complex of platinum.

It is preferred that the content of the curing catalyst is from 0.001 to 20 % by weight, in particular, from 0.01 to 15 % by weight in the silicone rubber composition.

Moreover, in addition to these components, a hydroxyl group-containing organopolysiloxane, a hydrolyzable functional group-containing silane (or siloxane), silica for the purpose of enhancing the strength of rubber, and a well-known silane coupling agent for the purpose of improving the adhesion may be contained. As the silane coupling agent, alkoxysilanes, acetoxysilanes, ketoximino silanes or the like are preferably used, and in particular, those having a vinyl group or an allyl group are preferably used.

### Condensation Reaction-Type Silicon Rubber

When the ink repellent layer 143 is made of condensation reaction-type silicon rubber, the ink repellent layer 143 is formed by applying a silicone rubber composition containing at least a hydroxyl group-containing organopolysiloxane, a cross-linking agent (deacetation type, deoximation type, dealcoholization type, deamination type, deacetonation type, deamidation type, deaminoxylation type, etc.), and a curing catalyst, and drying it as needed.

The hydroxyl group-containing organopolysiloxane has the structure represented by the above-described formula (A), which has a hydroxyl group at the end of its main chain or in the main chain. In particular, it is preferred that the hydroxyl group-containing organopolysiloxane having a hydroxyl group at the end of its main chain is preferably used. It is preferred that 50% or more of the entire R¹ and R² in the formula (A) are methyl groups. In addition, it is preferred that the weight average molecular weight of the hydroxyl group-containing organopolysiloxane is from 10,000 to 600,000.

As a cross-linking agent used for the condensation reaction-type silicone rubber layer, for example, acetoxysilanes such as methyl triacetoxysilane, ethyl triacetoxysilane, and vinyl triacetoxysilane, and ketoximino silanes such as vinyl methyl bis(methyl ethyl ketoximino) silane may be preferably used.

It is preferred that the content of the cross-linking agent is from 0.5 to 20 % by weight, in particular, from 1 to 15 % by weight in the silicone rubber composition.

The curing catalyst is selected from conventionally well-known curing catalysts, and in particular, dibutyl tin diacetate, dibutyl tin dioctoate, dibutyl tin dilaurate, zinc octoate, iron octoate may be preferably used. It is preferred that the content of the curing catalyst is from 0.001 to 15 % by weight, in particular, from 0.01 to 10 % by weight in the silicon rubber composition.

Moreover, in addition to these components, for the purpose of enhancing the strength of rubber, a well-known filler such as silica, and a well-known silane coupling agent may be contained. The thickness of the ink repellent layer 143 is not limited, but it is preferred that the thickness is from 2 µm to 10 µm, in view of the plate durability and the print reproducibility.

### Other Layers

The printing plate 14 which is a waterless planographic plate may include a primer layer between the base plate 141 and the laser heat-sensitive layer 142, in order to improve the adhesion between the base plate 141 and the laser heat-sensitive layer 142, and avoid transferring the heat of the heat-sensitive layer 142 irradiated with the laser beam to the base plate 141.

The primer layer may contain, for example, epoxy resin, polyurethane resin, phenolic resin, acrylic resin, alkyd resin, polyester resin, polyamide resin, urea resin, and polyvinyl butyral resin. In particular, for example, it is preferred that the polyurethane resin, the polyester resin, the acrylic resin, the epoxy resin, and the urea resin are used alone or in combination of two or more. In addition, the thickness of the primer layer is not limited.

Moreover, a cover film to protect the ink repellent layer 143 may be provided. It is preferred that this cover film can allow the laser beam to pass therethrough well. Examples of the cover film may include a polyester film, a polypropylene film, a polyvinyl alcohol film, a saponified ethylene-vinyl acetate copolymer film, a polyvinylidene chloride film, and a film on which various metals are deposited.

### Manufacture of Waterless Planographic Plate

An original waterless planographic plate as the printing plate 14 may be manufactured by a conventionally well-known method. For example, by using a usual coater such as a reverse roll coater, an air knife coater, a gravure coater, and a die coater, or a spin coating device, the base plate 141 is coated with a primer layer composition as needed, and heated at 100 to 300° C. for several minutes or cured by the irradiation of an active beam. After that, the laser heat-sensitive layer composition is applied and heated at 50 to 180° C. for several tens of seconds to several minutes, and therefore is cured to form the laser heat-sensitive layer 142. Next, the laser heat-sensitive layer 142 is coated with the silicone rubber composition and subjected to heat treatment at 50 to 200° C. for several minutes to form the ink repellent layer 143 made of silicone rubber. After that, a cover film is laminated or a protective layer is formed as needed, so that the original waterless planographic plate is manufactured.

The ink repellent layer 143 (or the cover film) of the original plate is irradiated with the laser beam like streaks from above, and exposed. After that, the irradiated part of the ink repellent layer 143 is removed to form the image areas 14A on which ink I is put. Consequently, the printing plate 14 as a waterless planographic plate is manufactured.

The printing plate 14 which is a waterless planographic plate with the above-described configuration prevents the ink from being murky, compared to a resin letterpress plate in which the image areas 14A with ink are formed by a resin layer (resin convex portions).

### Printing Operation of Printing Apparatus

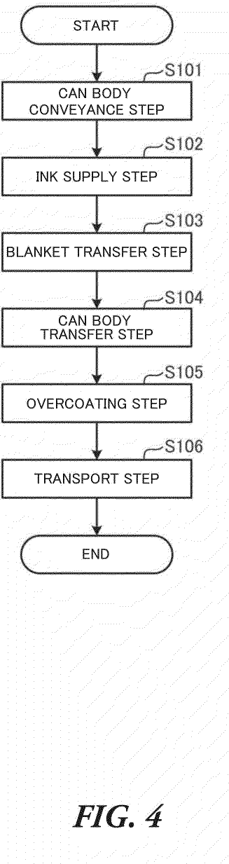

FIG. 4 is a flowchart illustrating the printing operation of the printing apparatus 1 on the can body P.

### Step S101: Can Body Conveyance Step

In step S101 as a can body conveyance step, the printing apparatus 1 conveys the can body P to the upper part of the mandrel wheel 40 by the conveyance unit 30. The printing apparatus 1 holds the can body P conveyed to the upper part of the mandrel wheel 40 by the mandrel 41. Before the can body P contacts the blanket 25, the printing apparatus 1 rotates the mandrel 41 to pre-spin the can body P, and then rotates the mandrel wheel 40 to move the can body P to the contact region where the can body P contacts the blanket 25. That is, the can body P rotates about its axis by the rotation of the mandrel 41, and revolves about the mandrel wheel 40 by the rotation of the mandrel wheel 40.

### Step S102: Ink Supply Step

In step S102 as an ink supply step following the step S101, the printing apparatus 1 rotates the ink roller group 12 of each of the plurality of ink supply parts 11 to supply the inks stored in the ink supply parts 11 to the printing plates 14 mounted to the plate cylinders 13.

In this step S102, the printing apparatus 1 supplies the ink in yellow (Y) from the first ink supply part 11a to the first printing plate 14a, supplies the ink in magenta (M) from the second ink supply part 11b to the second printing plate 14b, and supplies the ink in cyan (C) from the third ink supply part 11c to the third printing plate 14c.

By the rotation of the plate cylinders 13, the printing plates 14 to which inks have been supplied are moved to the contact regions where the printing plates 14 contact the blankets 25, respectively.

### Step S103: Blanket Transfer Step

In step S103 as a blanket transfer step following the step S102, the printing apparatus 1 rotates the blanket wheel 20 to contact the printing plates 14 to which the inks have been supplied, with the blankets 25, so that the inks on the printing plates 14 are transferred to the blankets 25. In this step S103, the printing apparatus 1 transfers the inks such that at least part of the ink transferred from one printing plate 14 is superimposed onto at least part of the inks in the other colors transferred from the other printing plates 14.

In the step S103, the printing apparatus 1 transfers the ink in yellow (Y) on the first printing plate 14a to one blanket 25, transfers the ink in magenta (M) on the second printing plate 14b to the same blanket 25, and then transfers the ink in cyan (C) on the third printing plate 14c to the same blanket 25.

By this means, the image having patterns of the ink repellent layers 143 formed in the printing plates 14 is transferred to the blanket 25.

### Step S104: Can Body Transfer Step

In step S104 as a can body transfer step following the step S103, the printing apparatus 1 rotates the blanket wheel 20 to move the blanket 25 to which the ink has been transferred to the contact region where the can body P contacts the blanket 25. Then, the printing apparatus 1 presses the can body P held by the mandrel 41 to allow contact between the can body P and the blanket 25 having been moved to the contact region, and therefore to transfer the ink on the blanket 25 to the can body P. By this means, the image having the patterns of the ink repellent layers 143 formed in the printing plates 14 is transferred to the can body P via the blanket 25.

### Step S105: Overcoating Step

In step S105 as an overcoating step following the step S104, the printing apparatus 1 rotates the mandrel wheel 40 to move the can body P to which the ink has been transferred to the varnish applicator 50, and further to move the can body P to the transport unit 60. Then, the printing apparatus 1 actuates the varnish applicator 50 to overcoat the can body P to which the ink has been transferred.

### Step S106: Transport Step

In step S106 as a transport step following the step S105, the printing apparatus 1 actuates the transport unit 60 to transport the can body P having passed through the varnish applicator 50 from the mandrel 41 to a dryer such as an oven (not illustrated).

Here, the printing apparatus 1 rotates the plate cylinders 13, the blanket wheel 20, the mandrels 41 and the mandrel wheel 40 in synchronization with each other. In addition, the printing apparatus 1 actuates the varnish applicator 50 and the transport unit 60 in synchronization with the rotations of the plate cylinders 13, the blanket wheel 20, the mandrels 41 and the mandrel wheel 40. In this way, the printing apparatus 1 prints the can body P.

### Configuration of Plate-Making System

Next, a plate-making system 100 configured to manufacture the printing plates 14 attached to the printing apparatus 1 will be described. The plate-making system 100 adopts DTP (Desk Top Publishing) and CTP (Computer To Plate). The plate-making system 100 manufactures the printing plates 14 which are waterless planographic plates described above.

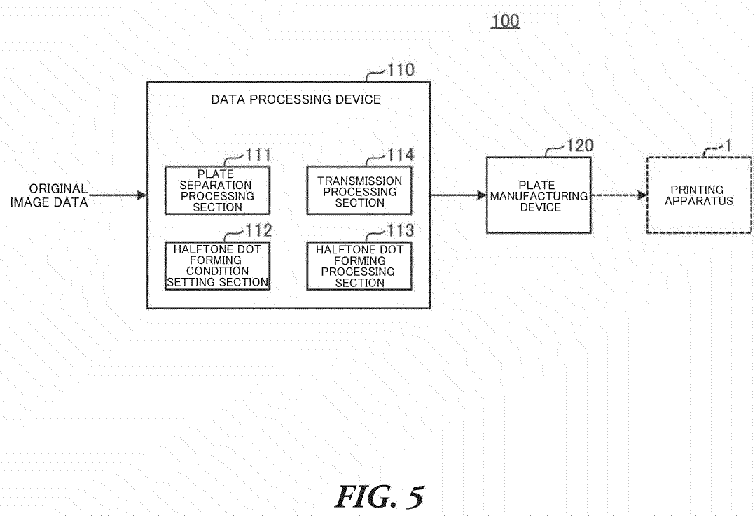

FIG. 5 is a block diagram illustrating the functions of the plate-making system 100 configured to manufacture the printing plates 14 attached to the printing apparatus 1. It is preferred that the plate-making system 100 illustrated in FIG. 5 is a system configured to manufacture the printing plates 14 by DLE (Direct Laser Engraving) method in which resin is sublimated by the heat of the laser and engraved, or LAMS (Laser Ablation Masking System) method in which an image is written to the surface of a resin plate by using the laser and is developed.

The plate-making system 100 includes a data processing device 110 configured to create plate-making image data by applying various image processing to original image data, and a plate manufacturing device 120 configured to manufacture printing plates based on the plate-making image data.

The data processing device 110 is configured to edit, for example, modify the layout and the color tone of the original plate-making image data described by the page-description language. Then, the data processing device 110 creates the plate-making image data by performing plate separation processing such as the color separation of process colors, and performing halftone dot forming processing to represent the shading of each of the colors by aggregation of halftone dots, and transmits the image data to the plate manufacturing device 120. The data processing device 110 includes a processor, a memory, and a program implementing the function of the data processing device 110.

The data processing device 110 includes a plate separation processing section 111 configured to perform plate separation processing, a halftone dot forming condition setting section 112 configured to set the conditions of the halftone dot forming processing, a halftone dot forming processing section 113 configured to perform the halftone dot forming processing, and a transmission processing section 114 configured to perform transmission processing to transmit data to the plate manufacturing device 120.

The plate separation processing section 111 separates the colors of the edited original image data into each of the process colors. The process colors may be yellow (Y) which is the color of the ink stored in the first ink supply part 11a, magenta (M) which is the color of the ink stored in the second ink supply part 11b, and cyan (C) which is the color of the ink stored in the third ink supply part 11c. The plate separation processing section 111 creates plate separation image data which is image data for each of the colors extracted by the color separation of the original image data.

The halftone dot forming condition setting section 112 sets halftone dot forming conditions to form halftone dots of the plate separation image data created by the plate separation processing section 111. The halftone dot forming conditions are set to the plate separation image data for each of the colors. The halftone dot forming conditions include the halftone dot shape, the halftone dot area ratio, the number of screen lines (the number of halftone dots lined up per unit area (1 inch)), and the screen angle (the angle at which halftone dots are lined up) for each of the colors, as well as the conditions for the overprint method. The conditions for the overprint method may include, for example, the condition for under color removal processing applied to a superimposed portion in which at least part of halftone dots in one color is superimposed onto at least part of halftone dots in the other colors to adjust or remove at least one of the other colors. “Halftone dot area ratio” referred herein means the percentage (%) of the halftone dot area per unit area in an image representing halftone dots formed by the halftone dot forming processing (halftone dot image).

### Under Color Removal Processing

The under color removal processing according to the present embodiment is performed by the halftone dot forming processing section 113, and applied to a superimposed portion in which at least part of halftone dots in one color is superimposed onto at least part of halftone dots in the other colors to adjust or remove at least one of the other colors. “Adjustment” of the color referred herein means to reduce the halftone dot area ratio (%) of at least one of the other colors in the superimposed portion. In addition, “removal” of the color referred herein means to completely remove (eliminate) at least one of the other colors in the superimposed portion.

The halftone dot forming condition setting section 112 sets the condition for the under color removal processing performed by the halftone dot forming processing section 113 as follows. In a case where the halftone dots of the plate separation image data in each color are formed by the overprint method, when, in the superimposed portion in which at least part of halftone dots in one color is superimposed onto at least part of halftone dots in the other colors, the sum of the halftone dot area ratios (%) of the one color and the halftone dot area ratio (%) of the other colors is equal to or smaller than a predetermined reference value (for example, 150 %), the halftone dot forming condition setting section 112 does not set anything to adjust or remove colors. On the other hand, when the sum is greater than the predetermined reference value (for example, 150 %), the halftone dot forming condition setting section 112 sets a changed value of the halftone dot area ratio (%) of at least one of the other colors to adjust or remove the color, so that the sum is equal to or smaller than the predetermined reference value. The halftone dot forming condition setting section 112 sets the above-described condition for the under color removal processing.

Here, as the condition for the under color removal processing, the halftone dot forming condition setting section 112 determines that the color to be adjusted or removed at the first priority is the color of the ink transferred first from the printing plates 14 to one blanket 25 (which is yellow (Y) transferred from the first printing plate 14a illustrated in FIG. 1 to the one blanket 25). In addition, the halftone dot forming condition setting section 112 determines that the color to be adjusted or removed at the second priority is the color of the ink transferred second from the printing plates 14 to the same blanket 25 (which is magenta (M) transferred from the second printing plate 14b illustrated in FIG. 1 to the same blanket 25).

In this way, as the condition for the under color removal processing, the halftone dot forming condition setting section 112 sets the priority of the colors to be adjusted or removed such that the colors are determined in the order from yellow (Y) to magenta (M).

Moreover, as the condition for the under color removal processing, the halftone dot forming condition setting section 112 sets the changed value of the halftone dot area ratio (%) of the color to be adjusted or removed. That is, to “adjust” the under color, the halftone dot area ratio (%) (for example, 50 %) of the under color initially set is changed to a predetermined value (for example, 20 %) greater than 0 %. Meanwhile, to “remove” the under color, the halftone dot area ratio (%) (for example, 50 %) of the under color initially set is changed to 0 %.

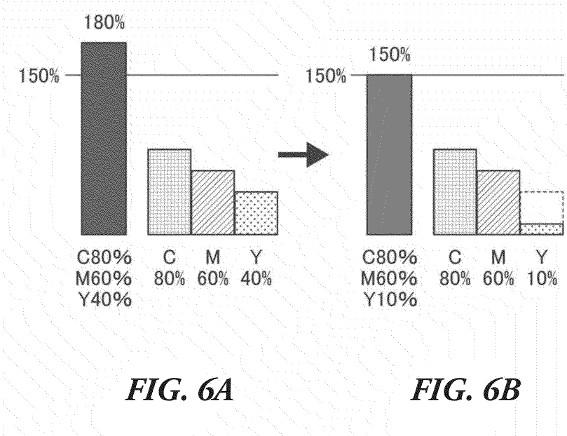

Hereinafter, specific examples of setting the condition for the under color removal processing will be described with reference to FIGS. 6A, 6B, 7A, 7B, and 8A-8C. FIGS. 6A and 6B illustrate a first example of setting the condition for the under color removal processing. With the overprint method, image data for a printed image has an overlap portion (image data portion) in which at least part of the halftone dots in magenta (M) is superimposed onto at least part of the halftone dots in yellow (Y), and at least part of the halftone dots in cyan (C) is further superimposed thereon.

With the first example, for example, as illustrated in FIG. 6A, in the image data for a printed image, the cyan (C) component having a halftone dot area ratio of 80 %, the magenta (M) component having a halftone dot area ratio of 60 %, and the yellow (Y) component having a halftone dot area ratio of 40 % overlap each other to form a superimposed portion having the sum of the halftone dot area ratios of 180 %. With the first example, the halftone dot forming condition setting section 112 sets the reference value (%) of the sum of the halftone dot area ratios to 150 %.

With the first example, the sum of the halftone dot area ratios of the three colors, yellow (Y), magenta (M), and cyan (C) is 180 %, and therefore is greater than the reference value of 150 % of the sum of the halftone dot area ratios.

To address this, with the first example, the halftone dot forming condition setting section 112 sets the condition for the under color removal processing to adjust yellow (Y) transferred first to one blanket 25 so that the sum of the halftone dot area ratios of the three colors, yellow (Y), magenta (M), and cyan (C) is equal to or smaller than the reference value of 150 %. To be more specific, the halftone dot forming condition setting section 112 adjusts the halftone dot area ratio of yellow (Y) from the initial value of 40 % to 10 % as illustrated in FIG. 6B (adjustment of yellow (Y)). By this means, the sum of the halftone dot area ratios is equal to the reference value of 150 %.

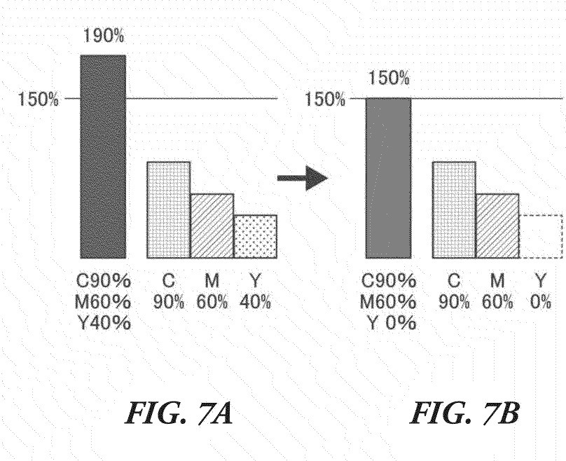

FIGS. 7A and 7B illustrate a second example of setting the condition for the under color removal processing. With the second example, for example, as illustrated in FIG. 7A, in the image data for a printed image, the cyan (C) component having a halftone dot area ratio of 90 %, the magenta (M) component having a halftone dot area ratio of 60 %, and the yellow (Y) component having a halftone dot area ratio of 40 % overlap each other to form a superimposed portion having the sum of the halftone dot area ratios of 190 %. Also with the second example, the halftone dot forming condition setting section 112 sets the reference value (%) of the sum of the halftone dot area ratios to 150 %.

With the second example, the sum of the halftone dot area ratios of the three colors, yellow (Y), magenta (M), and cyan (C) is 190 %, and therefore is greater than the reference value of 150 % of the sum of the halftone dot area ratios.

To address this, with the second example, the halftone dot forming condition setting section 112 sets the condition for the under color removal processing to remove yellow (Y) transferred first to one blanket 25 so that the sum of the halftone dot area ratios of the three colors, yellow (Y), magenta (M), and cyan (C) is equal to or smaller than the reference value of 150 %. To be more specific, the halftone dot forming condition setting section 112 changes the halftone dot area ratio of yellow (Y) from the initial value of 40 % to 0 % as illustrated in FIG. 7 (b) (removal of yellow (Y)). By this means, the sum of the halftone dot area ratios is equal to the reference value of 150 %.

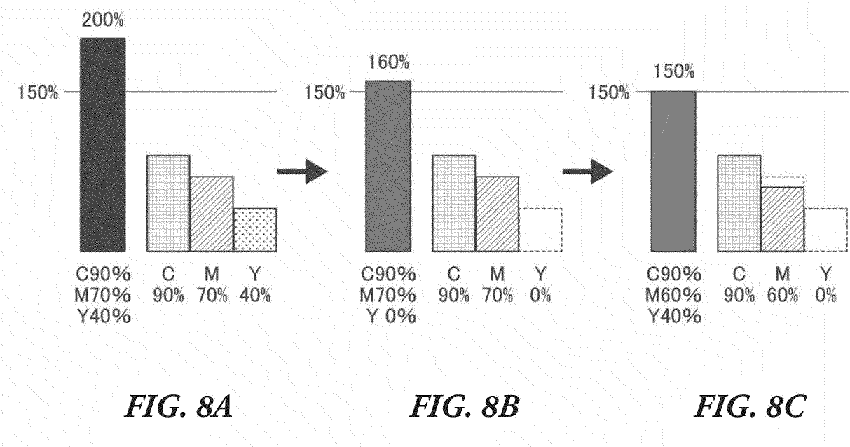

FIGS. 8A-8C illustrate a third example of setting the condition for the under color removal processing. With the third example, for example, as illustrated in FIG. 8A, in the image data for a printed image, the cyan (C) component having a halftone dot area ratio of 90 %, the magenta (M) component having a halftone dot area ratio of 70 %, and the yellow (Y) component having a halftone dot area ratio of 40 % overlap each other to form a superimposed portion having the sum of the halftone dot area ratios of 200 %. Also with the third example, the halftone dot forming condition setting section 112 sets the reference value (%) of the sum of the halftone dot area ratios to 150 %.

With the third example, the sum of the halftone dot area ratios of the three colors, yellow (Y), magenta (M), and cyan (C) is 200 %, and therefore is greater than the reference value of 150 % of the sum of the halftone dot area ratios.

To address this, with the third example, the halftone dot forming condition setting section 112 sets the condition for the under color removal processing to, first, remove yellow (Y) transferred first to one blanket 25 so that the sum of the halftone dot area ratios of the three colors, yellow (Y), magenta (M), and cyan (C) is equal to or smaller than the reference value of 150 %. To be more specific, the halftone dot forming condition setting section 112 changes the halftone dot area ratio of yellow (Y) from the initial value of 40 % to 0 % as illustrated in FIG. 8 (b) (removal of yellow (Y)). By this means, the sum of the halftone dot area ratios is 160 %, but is still greater than the reference value of 150 %.

Therefore, with the third example, the halftone dot forming condition setting section 112 sets, as the condition for the under color removal processing, to further adjust magenta (M) transferred second to the same blanket 25 as illustrated in FIG. 8C. To be more specific, as illustrated in FIG. 8C, the halftone dot forming condition setting section 112 changes the halftone dot area ratio of magenta (M) from the initial value of 70 % to 60 % (adjustment of magenta (M)). By this means, the sum of the halftone dot area ratios is equal to the reference value of 150 %.

The halftone dot forming processing section 113 forms halftone dots of the plate separation image data in each of the colors created by the plate separation processing section 111, based on the above-described halftone dot forming conditions set by the halftone dot forming condition setting section 112. The halftone dot forming processing section 113 forms halftone dots of the plate separation image data in the colors targeted for the overprint method as is on the positive condition (that, for each of the pixels, the higher the density of the color is, the higher the halftone dot area ratio is). The image data representing the halftone dots is binary data such as 1 bit TIFF (Tagged Image File Format). The image data representing the halftone dots is used as plate-making image data when the plate manufacturing device 120 manufactures a plurality of printing plates 14. The halftone dot forming processing section 113 may be configured as a software RIP (Raster Image Processor).

In the case where the halftone dot forming condition setting section 112 sets the condition for the under color removal processing as described above, the halftone dot forming processing section 113 adjusts or removes the under color based on the set condition to form halftone dots of the plate separation image data for each of the colors.

The transmission processing section 114 performs processing to transmit the image data representing the halftone dots formed by the halftone dot forming processing section 113 to the plate manufacturing device 120 as plate-making image data.

The plate manufacturing device 120 manufactures the printing plate 14 which is a waterless planographic plate for each of the colors based on the image data transmitted from the transmission processing section 114 of the data processing device 110, that is, the image data representing the halftone dots for each of the colors. The plate manufacturing device 120 forms the image areas 14A and the non-image areas 14B by exposing the ink repellent layer 143 (silicone resin layer) to the laser beam based on the image data representing the halftone dots for each of the colors, and peeling and removing the laser-irradiated part of the ink repellent layer 143. In this way, the printing plates 14 which are waterless planographic plates are manufactured. The printing plates 14 manufactured by the plate manufacturing device 120 are applicable to the printing apparatus 1.

### Plate-Making Operation by Plate-making System

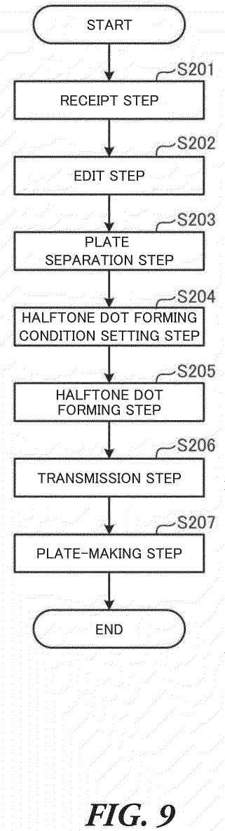

FIG. 9 is a flowchart illustrating plate-making operation to manufacture the printing plates 14 by using the plate-making system 100.

Step S201 to step S206 illustrated in FIG. 9 are performed by the data processing device 110, based on operation commands inputted by a user via a user interface provided in the data processing device 110. Step S207 is performed by the plate manufacturing device 120.

### Step S201: Receipt Step

In the step S201 as a receipt step, the plate-making system 100 receives original image data by the data processing device 110.

### Step S202: Edit Step

In step S202 as an edit step following the step S201, the plate-making system 100 edits the received original image data. The plate-making system 100 corrects the layout to match the printing area of a printed material, and modifies the color tone to edit the original image data.

### Step S203: Plate Separation Step

In step S203 as a plate separation step following the step S202, the plate-making system 100 applies plate separation processing to the edited original image data. The plate-making system 100 separates the colors of the edited original image data into each of the process colors, and creates the plate separation image data for each of the colors.

### Step S203: Halftone Dot Forming Condition Setting Step

In step S204 as a halftone dot forming condition setting step following the step S203, the plate-making system 100 performs halftone dot forming condition setting processing to set the halftone dot forming conditions for forming halftone dots of the plate separation image data created by the plate separation processing. In particular, the plate-making system 100 designates the plate separation image data in the colors targeted for the overprint method, and sets the conditions for the overprint method (such as the condition for the under color removal processing as described above), in addition to the halftone dot area ratio, the number of screen lines, and the screen angle per unit area (for example, per pixel) of the designated plate separation image data.

In this step S204, the plate-making system 100 causes the halftone dot forming condition setting section 112 to determine that the color to be adjusted or removed at the first priority is yellow (Y) transferred first to one blanket 25; and determine that the color to be adjusted or removed at the second priority is magenta (M) transferred second to the same blanket 25, as the condition for the under color removal processing performed by the halftone dot forming processing section 113.

Then, in the step S204, to form halftone dots of the plate separation image data for each of the colors by the overprint method, the plate-making system 100 causes the halftone dot forming condition setting section 112 to set, for the superimposed portion in which at least part of halftone dots in one color is superimposed onto at least part of halftone dots in the other colors, a changed value of the halftone dot area ratio (%) of one of the other colors to adjust or remove this color, so that the sum of the halftone dot area ratios (%) of the one color and the halftone dot area ratio (%) of the other colors is equal to or smaller than the predetermined reference value. The plate-making system 100 causes the halftone dot forming condition setting section 112 to set this condition for the under color removal processing.

### Step S205: Halftone Dot Forming Step

In step S205 as a halftone dot forming step following the step S204, the plate-making system 100 forms halftone dots of the plate separation image data created by the plate separation processing, based on the halftone dot forming conditions set by the halftone dot forming condition setting processing. Here, the plate-making system 100 forms the halftone dots of the plate separation image data in the colors targeted for the overprint method as is on the positive condition.

### Step S206: Transmission Step

In step S206 as a transmission step following the step S205, the plate-making system 100 performs transmission processing to transmit the image data representing the halftone dots formed by the halftone dot forming processing, as the plate-making image data, from the data processing device 110 to the plate manufacturing device 120.

### Step S207: Plate-Making Step

In step S207 as a plate-making step following the step S206, the plate-making system 100 manufactures a printing plate for each of the colors by the plate manufacturing device 120, based on the image data transmitted by the transmission processing. The plate-making processing illustrated in FIG. 9 ends at this step.

### Modification

The above-described embodiments including a modification may apply their features to each other. The above-described embodiments are not intended to limit the subject matter of the invention but may be modified to the extent not to depart from the scope of the claims.

For example, with the above-described embodiment, the process colors are three colors, cyan (C), magenta (M), and yellow (Y). However, the process colors may be seven colors, black (K), red (R), green (G), and blue (B), in addition to those three colors.

In addition, for example, with the above-described embodiment, the halftone dot forming condition setting section 112 may set a predetermined screen angle for each of the colors such that the screen angle of halftone dots (the angle at which halftone dots are lined up) varies for each of the colors as a halftone dot forming condition. By this means, a halftone dot image in which halftone dots in respective colors at screen angles different from each other are superimposed onto each other is printed on the outer circumferential surface (outer surface) of the can body P.

For example, the halftone dot forming condition setting section 112 may set, as a halftone dot forming condition, the screen angle of the halftone dots in yellow (Y) to 15 degrees, the screen angle of the halftone dots in magenta (M) to 75 degrees, and the screen angle of the halftone dots in cyan (C) to 45 degrees. In this way, the halftone dot forming condition setting section 112 sets the screen angle of the halftone dots which varies for each of the colors, and therefore it is possible to prevent the inks from being murky and prevent the occurrence of moire even though those colors are overprinted.

Moreover, with the above-described embodiment, the plurality of printing plates 14 are manufactured based on the plate-making image data representing halftone dots, but this is by no means limiting. For example, the plate-making image data of the plurality of printing plates 14 may include the image data of the image portion painted all over by the ink (solid image portion), in addition to the halftone dot image.

In this case, the plurality of printing plates 14 may be manufactured based on the plate-making image data in each of the colors having a superimposed portion in which at least part of the solid image portion in one color (for example, navy (N)) is superimposed onto at least part of the halftone dots in the other colors (for example, at least one of cyan (C), magenta (M), and yellow (Y)). By this means, it is possible to print an image having a superimposed portion in which at least part of the halftone dots in the other colors (for example, at least one of cyan (C), magenta (M), and yellow (Y)) is superimposed onto at least part of the one color (for example, navy (N)).

In this case, the plurality of printing plates 14 may be manufactured based on the plate-making image data having a superimposed portion in which at least part of a solid image portion in one color is superimposed onto at least part of the halftone dots in the other colors, and at least one of the other colors is adjusted or removed.

For example, with the example illustrated in FIG. 1, the fourth printing plate 14d may be manufactured based on the image data of the solid image portion. In this case, the image areas 14A of the fourth printing plate 14d manufactured based on the solid image portion is supplied with the ink in, for example, navy (N). Here, at least part of the solid image portion of the plate-making image data of the fourth printing plate 14d may be superimposed onto the other colors, that is, at least part of the halftone dots of the plate-making image data of at least one of the first printing plate 14a (yellow (Y)), the second printing plate 14b (magenta (M)), and the third printing plate 14c (cyan (C)). Then, at least one color of the halftone dots in the other colors may be adjusted or removed in the superimposed portion.

In this case, the halftone dot forming condition setting section 112 may set a condition to adjust or remove the colors sequentially in the order of yellow (Y) for the first printing plate 14a, magenta (M) for the second printing plate 14b, and cyan (C) for the third printing plate 14c according to the priority, based on the sum of the halftone dot area ratios (%) of yellow (Y), cyan (C), magenta (M) and navy (N), and the predetermined reference value, in the same way as the condition for the under color removal processing described above. Here, the halftone dot area ratio (%) of navy (N) is 100 % in the solid image portion.

According to the invention, it is possible to realistically printing precise designs on a can body.

1. A printing apparatus configured to print a can body, comprising:
a plurality of printing plates;
a blanket;
a blanket transfer device configured to transfer inks on the plurality of printing plates to the blanket; and
a can body transfer device configured to transfer the inks transferred to the blanket to the can body,
wherein the blanket transfer device transfers the inks such that at least part of an ink transferred from one printing plate is superimposed onto at least part of inks in other colors transferred from other printing plates.

2. The printing apparatus according to claim 1, wherein a halftone dot image is printed on an outer surface of the can body.

3. The printing apparatus according to claim 1, wherein the blanket transfer device does not allow an ink dry process to be performed until all the inks are transferred to the blanket.

4. The printing apparatus according to claim 1, wherein:
the plurality of printing plates are manufactured for respective colors depending on an image;
the inks corresponding to the colors are put on the plurality of printing plates, respectively; and
the inks put on the plurality of printing plates, respectively, are transferred to the blanket.

5. The printing apparatus according to claim 1, wherein:
the plurality of printing plates are manufactured based on a plate-making image having a superimposed portion in which at least part of halftone dots in one color is superimposed onto at least part of halftone dots in the other colors; and
at least one of the other colors is adjusted or removed in the superimposed portion.

6. The printing apparatus according to claim 1, wherein:
the plurality of printing plates are manufactured based on a plate-making image having a superimposed portion in which at least part of a solid image portion in one color is superimposed onto at least part of halftone dots in the other colors; and
at least one of the other colors is adjusted or removed in the superimposed portion.

7. The printing apparatus according to claim 5, wherein the color adjusted or removed in the superimposed portion is a color of an ink transferred first by the blanket transfer device.

8. The printing apparatus according to claim 5, wherein at least one of the other colors is adjusted or removed in the superimposed portion so that a sum of a halftone dot area ratio of the one color and a halftone dot area ratio of the other colors is equal to or smaller than a predetermined reference value.

9. The printing apparatus according to claim 5, wherein the color adjusted or removed in the superimposed portion is determined in an order of yellow (Y), magenta (M), and cyan (C), based on a sum of a halftone dot area ratio of the one color and a halftone dot area ratio of the other colors.

10. The printing apparatus according to claims 1, wherein each of the printing plates is a waterless planographic plate including an image area on which ink is put, and a non-image area on which ink is not put without water.

11. A printing method of printing a can body by a plurality of printing plates and a blanket, the printing method comprising:
transferring inks on the plurality of printing plates to the blanket; and
transferring the inks transferred to the blanket to the can body,
wherein the inks are transferred to the blanket such that at least part of an ink transferred from one printing plate is superimposed onto at least part of the inks in other colors transferred from other printing plates.

12. A can body printed by a printing apparatus, the printing apparatus comprising:
a plurality of printing plates;
a blanket;
a blanket transfer device configured to transfer inks on the plurality of printing plates to the blanket; and
a can body transfer device configured to transfer the inks transferred to the blanket to the can body,
wherein the blanket transfer device transfers the inks such that at least part of an ink from one printing plate is superimposed onto at least part of the inks in other colors transferred from other printing plates.

13. The can body according to claim 12, wherein a halftone dot image is printed on an outer surface of the can body, the halftone dot image being formed by superimposing at least part of halftone dots in a color with high lightness onto at least part of halftone dots in a color with low lightness.

14. The can body according to claim 12, wherein a halftone dot image in which halftone dots in respective colors at screen angles different from each other are superimposed onto each other is printed.
